(19) United States
(12) Patent Application Publication
(10) Pub. No.: US 2007/0231074 A1
(43) Pub. Date: Oct. 4, 2007

(54) Clamp to anchoring the production tube, the electrohydraulic hose and the electric cable simultaneously

(75) Inventor: Gilmar Souza Cupolillo, Rio de Janeiro-Rj-Cep (BR)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: IPBGR INDUSTRIA MECANICA LTDA, Rio de Janeiro (BR)

(21) Appl. No.: 11/267,573

(22) Filed: Nov. 7, 2005

(30) Foreign Application Priority Data
Nov. 5, 2004 (BR) 0404834-2

(51) Int. Cl. F16L 3/00

(52) U.S. Cl. 405/184.4

(57) ABSTRACT

The present invention refers to a improved clamp for use particularly in operations of oil searching in deep sea, comprising a pre-formed metallic belt (12) in which a rigid metallic curve (13) is welded to reinforce and protect the anchorage housing of the electro-hydraulic hose, in which in this said belt (12) being welded the rigid metallic curve (14) to reinforce and protect the electric cable anchorage housing, rigid symmetrical forks (15) and (16) welded in the rotation area of the screws that will be responsible by tighten of the screws, allowing to that area strength to the clamp, with three tips (26), (27) and (28), equidistant at 120°, a larger bore hole in the center (17), a medium bore hole in half oblong form (9) in said tip (27), a small bore hole in half oblong form (8) in said tip (26), and a bore slot (18) in said tip (28) suitable for the opening and closing of said clamp (1), with a small bore hole (10) located in one side of said slot (18), where two threaded casters (2) are set up, with smaller diameter than said hole (18), in order to become said caster (2) pivotable inside of said hole (18).

This application claims priority to Brazilian Application No. P10404834-2, filed Nov. 5, 2005, which is hereby incorporated by reference in its entirety.

### FIELD OF INVENTION

The present invention refers to a improved clamp. The clamp may be used in oil search operations at deep sea to anchor electro-hydraulic, electric or hydraulic hoses at production tube columns during installation and removal operations of sub sea Christmas trees (ANM). The clamp may include a housing to anchor the production tube, the electro-hydraulic cable, and the electric cable simultaneously, while also acting as a production tube column centralizer, presenting excellent impact strength, great flexibility, and low maintenance cost.

### BACKGROUND OF THE INVENTION

In preparation operations for oil searching in deep sea wells, several production tubes coiled to each other descend from the platform. These tubes may be used to drain the product or transport equipment involved in the operation up to and down from the platform. Clamps may be installed at the production tube to simultaneously anchor the production tube, an electro-hydraulic hose, and an electric cable.

The clamp anchors the electro-hydraulic hose and the electric or hydraulic cable at the production tube, with a 50 lbs.ft of torque, in order to avoid the compression of hydraulic lines, and to protect them of possible damages to the rubber lining, during the descent and ascent of the production tubes. The clamps may be inserted inside of another larger tube, whereby the external diameter of these clamps has friction with the internal diameter of the larger tube during the descent and the ascent of the production tubes. In the area between the internal diameter of the larger tube and the external diameter of the production tube, there is a chemical compound with great abrasive power, acting as hydrates formation inhibitor, in the area of the wellhead.

The clamps currently used present several problems during operation due to the process involving very considerable values of potential energy and friction forces as well as chemical attack to the clamp material. All these factors acting during the operation make the clamp currently used very vulnerable to fractures and chemical attacks due to its mechanical construction. The claim may include a blanket of vulcanized rubber in the metal with the purpose of guarantee a suitable tightness and avoiding the sliding of the clamp fitted on the tube. The clamp is tightened by means of screws and casters, with a 50-lbs.ft torque, using a pneumatic impact wrench. In the clamp used currently there are equidistant metallic plates screwed in the metal body 90 degrees apart, aimed to promote friction with the inner wall of the larger tube, protecting the metal body and, consequently, the electro-hydraulic hose and the electric cable. However, due to clamp chocks many of these wearing plates get loose, falling in the bottom of the well. Another problem is that the clamp has not flexibility, and to be made with no ductile materials, not absorbing small impacts that usually occurs against fixed parts of other equipments involved in the operations, causing the clamp breaking, and subsequent fall of metal parts at the bottom of the well, causing damages and lost of time. Another great problem is the great maintenance demand required after use, needing wash with fresh water under pressure, and immediate movable parts lubrication. Further, the use of metals with different characteristics being assembled to the clamp and having different electric potentials may result in a galvanic pile being formed in a marine environment.

The clamp currently used presents several problems, making the equipment very fragile before an operation that involves loads with great mass, with considerable mechanical demands. Therefore, an objective of the present invention is to present a improved clamp with high level of safety and very low maintenance request, developed after several studies and tests in field, with the advantage that whole body is rubber made, becoming it unbreakable after a fall, and extremely resistant to chemical attacks in marine environments.

In an embodiment, the invention involves a clamp for simultaneously anchoring the production tube, the electro-hydraulic hose, and the electric cable for use in deep sea oil search and production operations, in the production tube column in installation and uninstalling operations of sub sea Christmas trees (ANM), and with housings to simultaneously anchor the production tube, the electro-hydraulic cable and the electric cable, while also acting to centralize the production tubes into a column, comprising: a pre-formed metallic belt (12) in which a rigid metallic curve (13) is welded to reinforce and protect the hose electro-hydraulic hose anchorage housing, in which said belt (12) being welded the rigid metallic curve (14) to reinforce and protect the electric cable anchorage housing, rigid symmetrical forks (15) and (16) welded in the rotation area of the screws that will be responsible by tighten of the screws, allowing to that area strength to the clamp, with three tips (26), (27) and (28) equidistant at 120°, a larger bore hole in the center (17), a medium bore hole in half oblong form (9) in said tip (27), a small bore hole in half oblong form (8) in said tip (26), and a bore slot (18) in said tip (28) suitable for the opening and closing of said clamp (1), with a small bore hole (10) located in one side of said slot (18), where two threaded casters (2) are set up with smaller diameter than said hole (18) in order to make said caster (2) pivotable inside of said hole (18). In another aspect, the caster (2) is threaded a screw (4) with washer (3), in which a safety ring (5) is set up at the end to avoid the disassembly of the screw (4) in the counter-torque of clamp opening. In another aspect, the after whole welding process of the belt (12) curves (13) and (14), and forks (15) and (16), the rubber body of the clamp (1) is produced by vulcanization.

### DESCRIPTION OF THE DRAWINGS

Other objectives, characteristics, and advantages of the present invention will become more apparent from the following detailed description when view together with the accompanying drawings to the present specification, in which:

FIG. 1 is an exploded perspective view showing the overall clamp structure;

FIG. 2 is a drawing in a lateral plan view, showing the two tighten screws, clamp housings, and external form;

FIG. 3 is a drawing in plan view showing the clamp form and the fixation housings of the production tube, electro-hydraulic hose, and the electric cable, while also showing the opening of the clamp and the tighten mechanism;

FIG. 4 is a drawing in frontal plan view showing the whole clamp tighten mechanism as well as the symmetry in the clamp drawing;

FIG. 5 is a plan drawing showing a complete oil well operation with the clamps being used with all of the implications involved in the operation, in this case the clamps being surrounded by a larger diameter tube along the column;

FIG. 6 is a perspective drawing in detail enlarged from the FIG. 5, with purpose to better show the assembly of the clamp at the production tube, fastening the electro-hydraulic hose and the electric cable, also showing the larger diameter tube which involves the clamps along the column. In this detail it is also possible to visualize that all ANM set, production tube and larger diameter tube stay fixed at the bottom of the sea connected to the wellhead in spite of the platform flotation caused by sea waves, provoking longitudinal and traverse movements of whole column, causing friction forces and drag between the larger diameter tube and the clamps;

FIG. 7 is a plan drawing, showing an operation in open sea of descent or ascent of submerged equipments in an oil well, with the clamps being used with the implications that involve the operation, in this case with the tube surrounding the clamps, wherein the clamps are in direct contact with the sea water along the column, however in this operation mode there are sea currents in all directions, which may co-operate to the open of the clamps due to the force of currents acting in the electro-hydraulic hose and the electric cable;

FIG. 8 is a enlarged perspective drawing from FIG. 7, with the objective to better show the clamp assembly in the production tube, fastening the electro-hydraulic hose and the electric cable; and

FIGS. 9 and 10 are respectively drawings in the frontal plan view and view in plant, showing the larger diameter tube crossed, which involves the clamp in an operation of descent or ascent of the production tubes. This drawing shows in a clear way an improvement of the invention that is the centralization of the production tubes column, through the clamps, in function of the minimum space between the external faces of the clamp and the larger diameter tube that involves them.

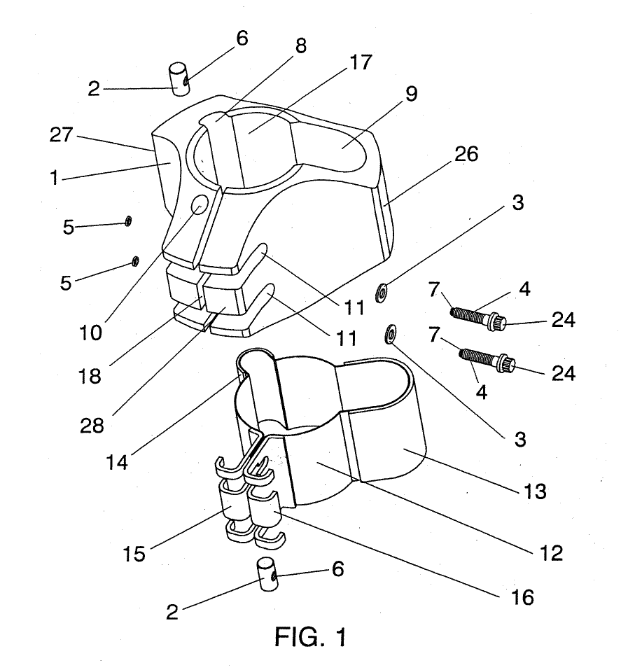

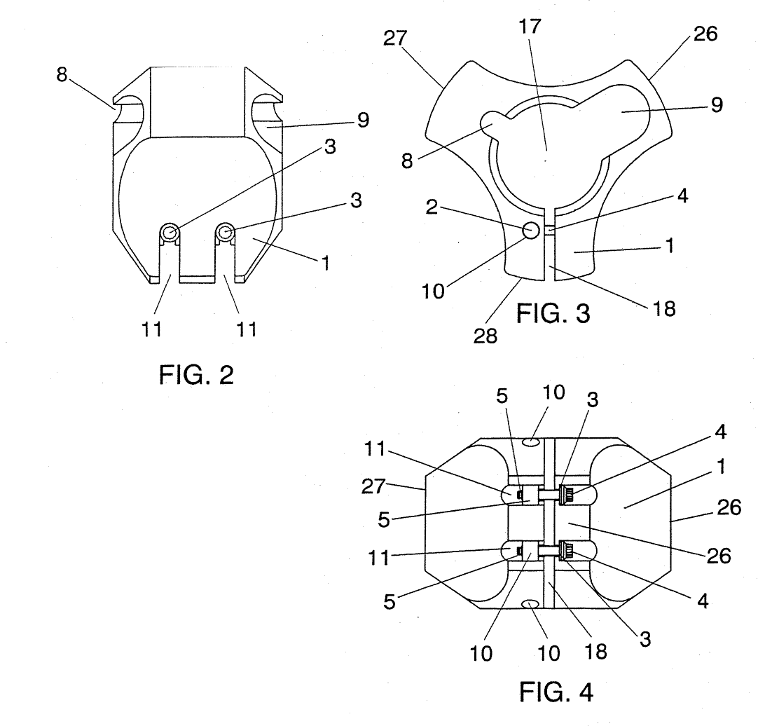

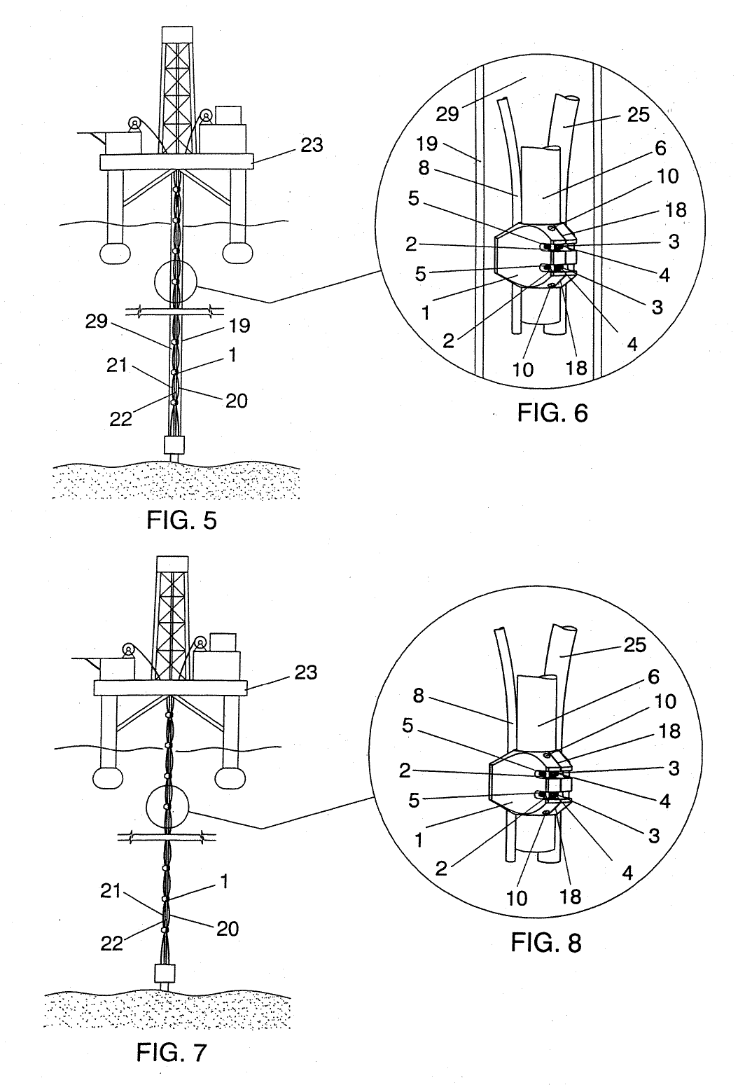

### DETAILED DESCRIPTION OF THE INVENTION

As observed from the Figures in that identical numeric references identify corresponding parts, the present invention involves a clamp 1 having geometry that allows the centralization of the column into the diameter tube. In an embodiment, the clamp utilizes nitrilic rubber in the external lining allowing a better strength to chocks and impacts in cases of collisions against other baffle plates, with the further advantage that nitrilic rubber presents a satisfactory strength against sea water and to other chemical compounds.

The improved clamp 1 is manufactured from a preformed metallic belt 12 in which a rigid metallic curve 13 is welded to reinforce and protect the anchorage housing of the electro-hydraulic hose. The belt 12 includes a rigid metallic curve 14 joined to it to reinforce and protect the anchorage housing of the electric cable to the belt 12. Rigid symmetrical forks 15 and 16 are welded in the rotation area of the screws that works to tighten the screws and improving the strength of the clamp in that area. After the welding process of the belt 12, and the curves 13 and 14, and forks 15 and 16 is accomplished, the vulcanization to produce the rubber body of the clamp 1 is performed.

To operate the clamp 1, two casters 2, which are treated to support high torque, are introduced in the hole 10. The casters provide rotational movement inside of the hole. The casters also providing rotation movement to the screws 4 around the axis of the caster 2, allowing the opening and closuring of clamp 1. The screws 4 receive two washers 3 that will act as a sliding surface of the screw head 24 during the torque application to tighten the clamp 1 using a pneumatic impact wrench. After the assembly of the washers 3 in the screws 4, the screws 4 are threaded into casters 2. Locking rings 5 may be provided in the tip of the screws 4, which may include a housing 7 designed to interface with the locking rings, to prevent disassembly of the screw 4 from the caster 2 when the screws are subjected to a counter-torque when the clamp is opened thereby acting as a safety device during operation.

The improved clamp 1 provides specific advantages for use in support operations for oil searching in deep sea, with the objective of anchoring simultaneously the production tube 6 in a large, central hole 17, the hydraulic hose 25 in a medium hole 9, and the electric cable in a small hole 8. The clamp is then fastened with screws 3, which are pivoted and then tightened with a torque value about 50 lbs.ft.

In an embodiment of the invention, clamp 1 is manufactured with 90% nitrilic rubber with density 1.18, which is capable of floating when immersed in well fluid, and resists impact and chemical attacks originating from of the completion operations of underwater wells. Alternatively the clamp 1 may be manufactured from engineering plastic material.

In an embodiment of the invention, clamp 1 supports the installation in depths of about 2500 meters in water, while resisting to crushing pressures about 256 kgf/cm2 throughout its whole body.

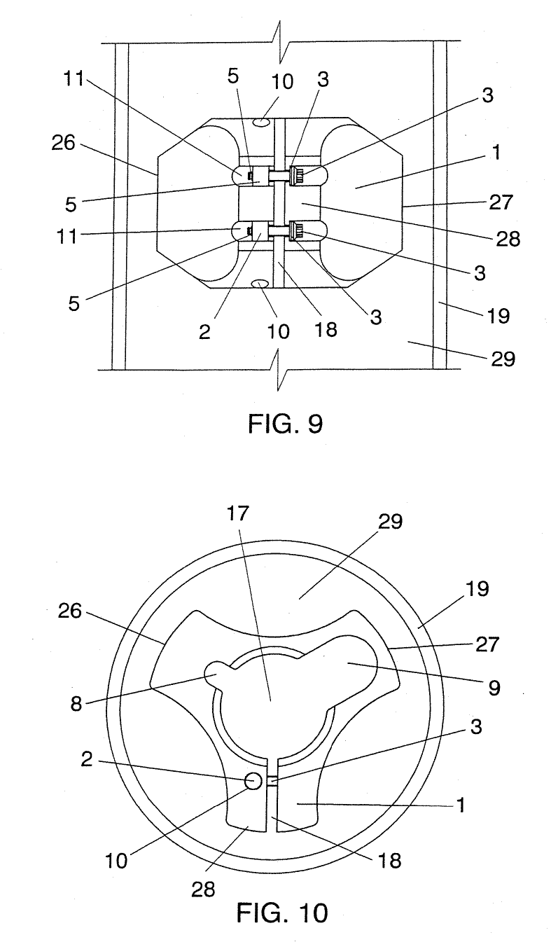

In an embodiment of the invention, clamp 1 provides a geometric form (FIG. 3) allowing the centralization into production tubes into a column. FIGS. 9 and 10 depict the clamp inserted into the column having a larger diameter 19 than the tubes. In an embodiment of the invention, the tips 26, 27 and 28 are designed to minimize wear caused by friction between the clamp and the inner wall of the larger tube 19.

1.- A clamp for simultaneously anchoring the production tube, the electro-hydraulic hose, and the electric cable comprising: a pre-formed metallic belt (12) in which a rigid metallic curve (13) is welded to reinforce and protect the hose electro-hydraulic hose anchorage housing, in which said belt (12) being welded the rigid metallic curve (14) to reinforce and protect the electric cable anchorage housing, rigid symmetrical forks (15) and (16) welded in the rotation area of the screws that will be responsible by tighten of the screws, allowing to that area strength to the clamp, with three tips (26), (27) and (28) equidistant at 120°, a larger bore hole in the center (17), a medium bore hole in half oblong form (9) in said tip (27), a small bore hole in half oblong form (8) in said tip (26), and a bore slot (18) in said tip (28) suitable for the opening and closing of said clamp (1), with a small bore hole (10) located in one side of said slot (18), where two threaded casters (2) are set up with smaller diameter than said hole (18) in order to make said caster (2) pivotable inside of said hole (18).

2.- The clamp of claim 1 wherein in each said caster (2) is threaded a screw (4) with washer (3) in which a safety ring (5) is set up at the end to avoid the disassembly of the screw (4) in the counter-torque of clamp opening.

3.- The clamp of either claim 1 or 2, wherein after whole welding process of the belt (12) curves (13) and (14), and forks (15) and (16), is accomplished the vulcanization to produce the rubber body of the clamp (1).
